(19) United States
(12) Patent Application Publication
(10) Pub. No.: US 2012/0286748 A1
(43) Pub. Date: Nov. 15, 2012

(54) BUCK CONVERTER

(75) Inventors: KAI-FU CHEN, Tu-Cheng (TW); CHIA-YUN LEE, Tu-Cheng (TW); CHUANG-WEI TSENG, Tu-Cheng (TW)

(73) Assignee: HON HAI PRECISION INDUSTRY CO., LTD., Tu-Cheng (TW)

(21) Appl. No.: 13/173,203

(22) Filed: Jun. 30, 2011

(30) Foreign Application Priority Data
May 10, 2011 (TW) 100116253

(51) Int. Cl. G05F 1/10

(52) U.S. Cl. 323/271

(57) ABSTRACT

A buck converter includes an input terminal, two MOSFETs, a PWM module and a control module. The input terminal is coupled to a power source to provide power to the buck converter. The PWM module is coupled to the gates of the two MOSFETs to alternately turn on and turn off the two MOSFETs. The control module is configured to shut down the power source if a drain-source resistance or a gate-source resistance in either one of the two MOSFETs is not within normal values when the two MOSFETs are turned off.

### 1. TECHNICAL FIELD

The disclosure generally relates to a buck converter.

### 2. DESCRIPTION OF RELATED ART

Buck converters generally include two metal oxide semiconductor field effect transistors (MOSFETs) connected in series. A pulse width modulation (PWM) module provides a gate driver to the gates of the two MOSFETs to switch between the two MOSFETs. However, if one of the two MOSFETs fails, other elements in the buck converter may be damaged.

Therefore, an improved buck converter is desired to overcome the above described shortcomings.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is an illustrative view of a buck converter in accordance with an embodiment.

FIG. 2 is an illustrative view of a control module as shown in FIG. 1.

### DETAILED DESCRIPTION

An embodiment of the present disclosure will now be described in detail below and with reference to the drawings.

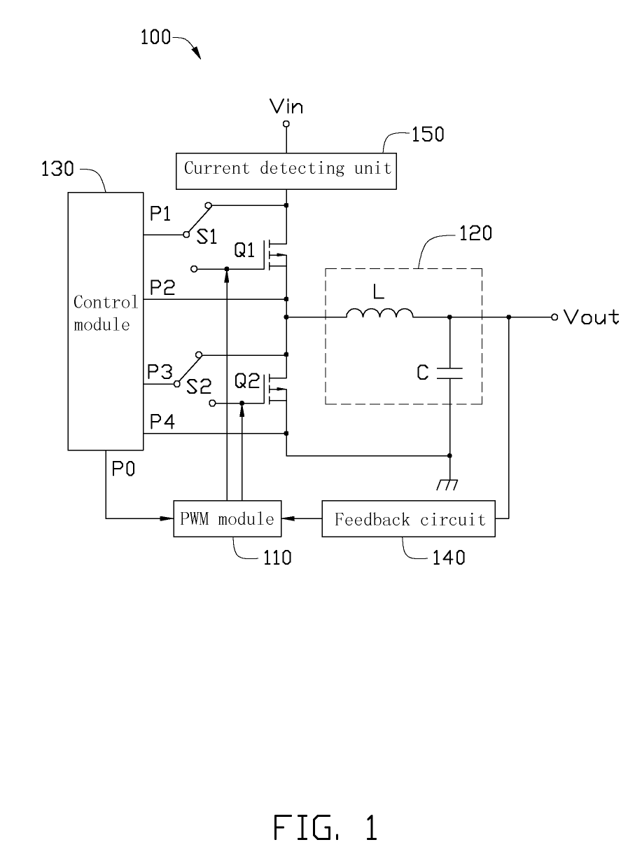

Referring to FIG. 1, a buck converter 100 in accordance with an embodiment includes an input terminal Vin, an output terminal Vout, a first MOSFET Q1, a second MOSFET Q2, a PWM module 110, a filter circuit 120, a control module 130 and a feedback circuit 140.

The input terminal Vin is coupled to a power source to provide power to the buck converter 100. The output terminal Vout outputs a direct current (DC) voltage to a load.

A drain of the first MOSFET Q1 is coupled to the input terminal Vin, and a source of the first MOSFET Q1 is coupled to a drain of the second MOSFET Q2. A source of the second MOSFET Q2 is coupled to ground. In this embodiment, the first MOSFET Q1 and the second MOSFET Q2 are both N-channel normally off MOSFETs.

The PWM module 110 is coupled to the gates of the first MOSFET Q1 and the second MOSFET Q2, to turn on and turn off the first MOSFET Q1 and the second MOSFET Q2 alternately. That is, when the PWM module 120 provides a high level signal to turn on the first MOSFET Q1, a synchronous low level signal is provided to turn off the second MOSFET Q2. Similarly, when the PWM module 120 provides a high level signal to turn on the second MOSFET Q2, a synchronous low level signal is provided to turn off the first MOSFET Q1.

The filter circuit 120 is coupled between the source of the first MOSFET Q1 and an output terminal Vout of the buck converter 100, to provide a DC voltage at the output terminal Vout. In this embodiment, the filter circuit 120 includes an inductor L and a capacitor C. One terminal of the inductor L is coupled to the source of the first MOSFET Q1, and the other terminal of the inductor L is coupled to the output terminal Vout. One terminal of the capacitor C is coupled to the output terminal Vout, and the other terminal of the capacitor C connects to ground.

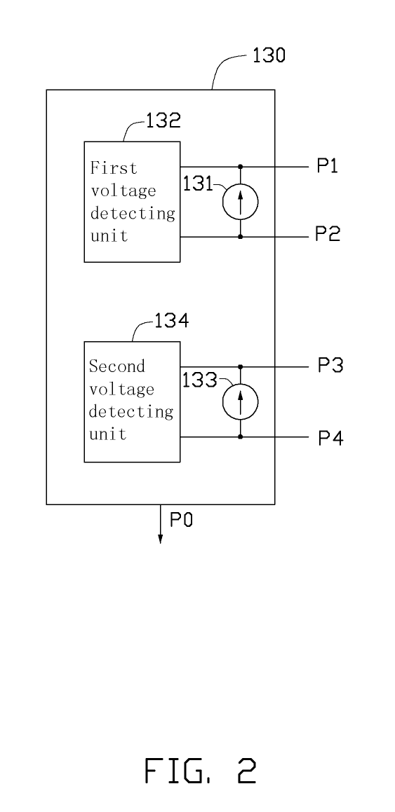

The control module 130 has an output node P0 coupled to the PWM module 110. The control module 130 is configured to shut down the power source if a drain-source resistance or a gate-source resistance of the first MOSFET Q1 is not within normal values when the first MOSFET Q1 is turned off. Referring also to FIG. 2, the control module 130 includes a first current source 131 and a first voltage detecting unit 132. The two terminals of the current source 131 correspond to the two output nodes P1 and P2 of the control module 130. The output node P1 is selectively coupled to the drain or the source of the first MOSFET Q1 by a first switch S1. The output node P2 is coupled to the source of the first MOSFET Q1. When detecting the drain-source resistance of the first MOSFET Q1, the first switch S1 is in a first condition, to connect the output node P1 with the drain of the first MOSFET Q1. Then, the control module 130 outputs a control signal to the PWM module 110 through the output node P0. The PWM module 110 provides a low level signal to turn off the first MOSFET Q1. At this time, the control module 130 maintains a constant current across the drain and the source of the first MOSFET Q1 by means of the first current source 131. Therefore, any voltage between the drain and the source of the first MOSFET Q1 can be detected by the first voltage detecting unit 132, and the drain-source resistance of the first MOSFET Q1 can be calculated. After that, the first switch S1 changes to a second condition to connect the output node P1 with the gate of the first MOSFET Q1. The control module 130 maintains a constant current across the gate and the source of the first MOSFET Q1 by means of the first current source 131. Therefore, any voltage between the gate and the source of the first MOSFET Q1 can be detected by the first voltage detecting unit 132, and the gate-source resistance of the first MOSFET Q1 can be calculated. The drain-source resistance and the gate-source resistance of the first MOSFET Q1 as calculated are then compared with normal values for these items. If the calculated drain-source resistance or gate-source resistance is not within normal values, the control module 130 will shut down the power source to prevent damage to other elements in the buck converter 100. Generally, the drain-source resistance or the gate-source resistance of the first MOSFET Q1 when the first MOSFET Q1 is turned off has a value greater than 10⁶Ω. If the calculated drain-source resistance or the gate-source resistance is less than that figure, it will be determined that the first MOSFET has failed and the control module 130 will shut down the power source.

The buck converter 100 can further include a feedback circuit 140. The feedback circuit 140 is coupled between the output terminal Vout of the buck converter 100 and the PWM module 110. If the output voltage at the output terminal Vout deviates from normal values, the feedback circuit 140 will provide a control signal to change a duty cycle of the signals generated by the PWM module 110. Therefore, by detecting the output voltage at the output terminal Vout, the feedback circuit 150 can keep the output voltage at the output node Vout to a constant value.

The buck converter 100 can further include a current detecting unit 150. The current detecting unit 150 is coupled between the drain of the first MOSFET Q1 and the input terminal Vin for detecting current flowing through the drain and the source of the first MOSFET Q1.

The control module 130 may also shut down the power source if a drain-source resistance or a gate-source resistance of the second MOSFET Q2 is not within normal values when the second MOSFET Q2 is turned off. Referring also to FIG. 2, the control module 130 further includes a second current source 133 and a second voltage detecting unit 134. The two terminals of the current source 133 correspond to the two output nodes P3 and P4 of the control module 130. The output node P3 is selectively coupled to the drain or the source of the second MOSFET Q2 by a second switch S2. The output node P4 is coupled to the source of the second MOSFET Q2. When detecting the drain-source resistance of the second MOSFET Q2, the second switch S2 is in a first condition to connect the output node P3 with the drain of the second MOSFET Q2. Then, the control module 130 outputs a control signal to the PWM module 110 through the output node P0 and the PWM module 110 provides a low level signal to turn off the second MOSFET Q2. At this time, the control module 130 maintains a constant current across the drain and the source of the second MOSFET Q2 by means of the second current source 133. Therefore, any voltage between the drain and the source of the second MOSFET Q2 can be detected by the second voltage detecting unit 134, and the drain-source resistance of the second MOSFET Q2 when the second MOSFET Q2 is turned off can be calculated. After that, the second switch S2 changes to a second condition to connect the output node P3 with the gate of the second MOSFET Q2. The control module 130 maintains a constant current across the gate and the source of the second MOSFET Q2 by means of the second current source 133. Therefore, any voltage between the gate and the source of the second MOSFET Q2 can be detected by the second voltage detecting unit 134 and the gate-source resistance of the second MOSFET Q2 when the second MOSFET Q2 is turned off can be calculated. The drain-source resistance and the gate-source resistance of the second MOSFET Q2 as calculated are then compared with normal values for these items. If the calculated drain-source resistance or gate-source resistance is not within normal values, the control module 130 will shut down the power source to prevent damage to other elements in the buck converter 100.

It is believed that the present embodiments and their advantages will be understood from the foregoing description, and it will be apparent that various changes may be made thereto without departing from the spirit and scope of the disclosure or sacrificing all of its material advantages, the examples hereinbefore described being merely preferred or exemplary embodiments of the disclosure.

What is claimed is:

1. A buck converter, comprising:
an input terminal and an output terminal, the input terminal being adapted for connecting a power source, the output terminal being adapted for connecting a load;
a first MOSFET comprising a drain coupled to the first output terminal, a gate, and a source;
a second MOSFET comprising a drain coupled to a source of the first MOSFET, a source coupled to ground and a gate;
a PWM module, coupled to the gates of the first MOSFET and the second MOSFET to alternatively turn on the first MOSFET and the second MOSFET;
a filter circuit, coupled between the source of the first MOSFET and the output terminal; and
a control module, coupled to the PWM module, the control module being configured to shut down the power source if a drain-source resistance or a gate-source resistance of the first MOSFET is not within normal values when the first MOSFET is turned off.

2. The buck converter of claim 1, wherein the filter circuit comprises an inductor and a first capacitor, the inductor is coupled between the source of first MOSFET and the output node of the buck converter, and the first capacitor is coupled between the output node of the buck converter and ground.

3. The buck converter of claim 1, further comprising a feedback circuit coupled between the output terminal and the PWM module.

4. The buck converter of claim 1, wherein the control module has a first output node and a second output node, the second output node is coupled to the source of the first MOSFET, and the first output node is selectively coupled to the drain or the gate of the first MOSFET by a first switch.

5. The buck converter of claim 4, wherein the control module comprises a first current source and a first voltage detecting unit, two terminals of the first current source are corresponding to the first output node and the second output node of the control module, the first current source is configured to provide a constant current to the drain and the source of the first MOSFET or the gate and the source of first MOSFET, and the first voltage detecting unit is configured to obtain a voltage between the drain and the source of the first MOSFET or the gate and the source of the first MOSFET.

6. The buck converter of claim 1, further comprising a current detecting unit coupled between the drain of the first MOSFET and the input terminal.

7. The buck converter of claim 1, wherein the control module shuts down the power source if a drain-source resistance or a gate-source resistance of the second MOSFET when the second MOSFET is turned off.

8. The buck converter of claim 7, wherein the control module has a third output node and a fourth output node, the fourth output node is coupled to the source of the second MOSFET, the third output node is selectively coupled to the drain or the gate of the second MOSFET by a second switch.

9. The buck converter of claim 8, wherein the control module comprises a second current source and a second voltage detecting unit, two terminals of the second current source are corresponding to the third output node and the fourth output node of the control module, the first current source is configured to provide a constant current to the drain and the source of the first MOSFET or the gate and the source of first MOSFET, and the first voltage detecting unit is configured to obtain a voltage between the drain and the source of the first MOSFET or the gate and the source of the first MOSFET.
